(19) United States
(12) Patent Application Publication
(10) Pub. No.: US 2004/0222954 A1
(43) Pub. Date: Nov. 11, 2004

(54) Methods and apparatus for a display

(76) Inventor: Ernst H. Lueder, Scottsdale, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 10/816,742

(22) Filed: Apr. 2, 2004

Related U.S. Application Data
(60) Provisional application No. 60/460,393, filed on Apr. 7, 2003.
(60) Provisional application No. 60/470,978, filed on May 19, 2003.
(60) Provisional application No. 60/479,955, filed on Jun. 20, 2003.
(60) Provisional application No. 60/497,698, filed on Aug. 26, 2003.

(51) Int. Cl. G09G 3/36

(52) U.S. Cl. 345/87

(57) ABSTRACT

Methods and apparatus for a display include a display panel, a feedback sensor, and a control circuit. In one embodiment, the control circuit uses the feedback sensor to adjust the brightness of the optical cells in the display panel.

### CROSS-REFERENCES TO RELATED APPLICATIONS

This application claims the benefit of:

U.S. Provisional Patent Application No. 60/460,393, filed Apr. 7, 2003;

U.S. Provisional Patent Application No. 60/470,978, filed May 19, 2003;

U.S. Provisional Patent Application No. 60/479,955, filed Jun. 20, 2003; and

U.S. Provisional Patent Application No. 60/497,698, filed Aug. 26, 2003;

and incorporates the disclosure of each application by reference. To the extent that the present disclosure conflicts with any referenced application, however, the present disclosure is to be given priority.

### FIELD OF THE INVENTION

The invention relates to methods and apparatus for implementing and/or controlling displays.

### BACKGROUND OF THE INVENTION

Display systems find many uses in a variety of applications, such as computers, televisions, point-of-sale terminals, mobile phones, test equipment, and other electronic systems. For certain types of displays, in particular displays that use OLED or LCD technology, display brightness and uniformity deteriorates as the optical elements that form the display age. Brightness may also vary significantly according to manufacturing variations, operating conditions, interference due to crosstalk, and other causes.

### BRIEF DESCRIPTION OF THE DRAWING

A more complete understanding of the present invention may be derived by referring to the detailed description when considered in connection with the following illustrative figures. In the following figures, like reference numbers refer to similar elements and steps.

FIG. 1 is a block diagram of a display system according to the various aspects of the present invention.

FIG. 2 is a schematic diagram of a display system with two row electrodes and three column electrodes per optical cell.

FIGS. 3A-B are diagrams of photo resistors adapted for use as a feedback sensor.

FIGS. 4-6 are block diagrams of systems for storing pre-adjustment values for use with an incremental target value.

FIG. 7 is a block diagram of a display system having a signal generator, a comparing circuit, and a switch.

FIG. 8 is a block diagram of a control circuit having a voltage generator and a selector.

FIG. 9 is a block diagram of a display system with a common voltage generator for all columns.

FIG. 10 is a block diagram of a display system with with a common increasing voltage generator and a pixel discharge circuit.

FIG. 11 is a block diagram of a pixel control circuit implemented with a voltage controlled current source.

FIG. 12 is a schematic diagram of a display system using a resistor feedback sensor that is common to all optical cells of a column.

FIG. 13 is a diagram of a display system using a resistor feedback sensor in each optical cell.

FIG. 14 is a diagram of a display with one row electrode and two column electrodes per optical cell and a feedback sensor that continuously reads the currents flowing in the optical cells of a column.

FIG. 15 is a diagram of an active maintenance circuit.

FIG. 16 is a diagram of an LCD display system.

FIG. 17 is a diagram of increasing signals corresponding to different drive voltages.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention is described partly in terms of functional components and various assembly and/or operating steps. Such functional components and steps may be realized by any number of components and steps configured to perform the specified functions and achieve the various results. For example, the present invention may employ various elements, materials, configurations, sensors, displays, circuit elements, integrated circuits, and the like, which may carry out a variety of functions. In addition, the present invention may be practiced in conjunction with any number of applications, environments, and display systems, and the systems and components described are merely exemplary applications for the invention. Further, the present invention may employ any number of conventional techniques for manufacturing, assembling, integration of elements, and the like.

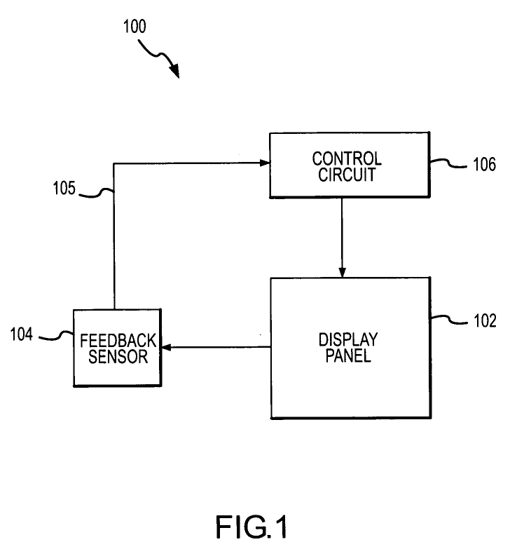

Referring now to FIG. 1, a display system 100 configured for controlling pixel brightness according to various aspects of the present invention comprises a display panel 102, a feedback sensor 104, and a control circuit 106. The display system 100 may be used for any suitable purpose or combination of purposes, such as displaying alpha-numeric information, graphical representations, information or graphics as a still image, a series of still images, or images displayed to form motion pictures. Information for display can come from any suitable source, such as a computer, a memory device, an electromechanical sensor, a television signal feed, a camera, a transducer, or the like. The display system 100 provides images on the display panel 102 according to the received information. The feedback sensor 104 generates a feedback signal 105, which is provided to the control circuit 106 to adjust the brightness of the individual optical cells.

The display panel 102 is configured to display information in response to signals from a source. Any suitable technology or combination of technologies may be used to implement the display panel 102, such as thin film components, semiconductors, biomaterials, liquid crystal, organic light emitting diodes, plasma, or photonic elements. An exemplary display panel 102 of the present embodiment comprises an array of optical cells, for example pixels, individual bulbs, light-emitting diodes, or light valves accessed via a set of row electrodes and a set of column electrodes. Each optical cell may include one or more optical elements, the brightness of which may be individually controlled to emit or transmit light to a viewer to form a composite image. In the present exemplary embodiments, the optical elements of the display panel 102 comprise organic light emitting diodes (OLEDs) and liquid crystal (LC) cells. The optical elements may, however, comprise any suitable light-controlling elements.

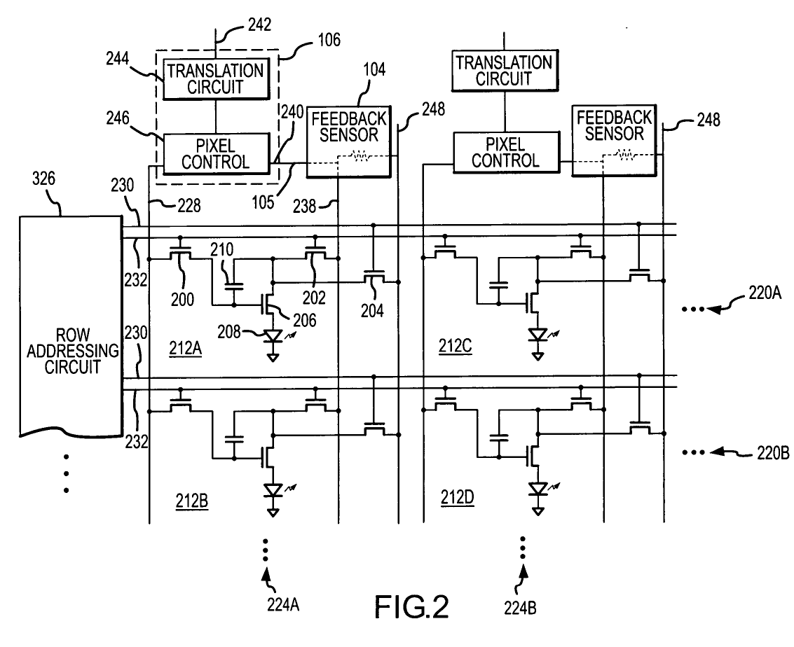

The optical cell configuration of the display panel 102 may be selected according to any appropriate criteria or design. Referring to FIG. 2, in an exemplary embodiment, the display panel 102 comprises a matrix of optical cells 212A-D organized into multiple rows 220A-B and columns 224A-B. The number of rows 220 and columns 224 may be selected according to any appropriate criteria, such as the size and resolution of the display panel 102.

Each optical cell 212 is configured to selectively provide light according to the signals from the control circuit 106. The individual optical cells 212 may be addressed and driven according to any appropriate system or technique to control the image rendered on the display panel 102 and the brightness of the individual optical cells 212. Each optical cell 212 of the present embodiment includes at least one control input, such that signals applied to the control input control the brightness of the optical cell 212. In the present matrix configuration, each optical cell 212 in a row 220 is connected to at least one row selection electrode 232, and each optical cell 212 in a column 224 is selectively connected to at least one column electrode 228, for example via the control input. The light generated or transmitted by the optical cell 212 varies according to signals received from the control circuit 106 via the column electrode 228. The row selection electrode 232 facilitates selective connection of the optical cells 212 in a row 220 to their respective column electrodes 228.

The optical cells 212 may be controlled according to any desired technique, such as controlling all optical cells 212 simultaneously, all optical cells 212 in a row 220, all optical cells 212 in a column 224, or by individually controlling each optical cell 212 in any row 220 or column 224. In the present exemplary embodiment using a conventional OLED or LC display panel 102, the optical cells 212 are accessed by simultaneously addressing optical cells 212 in a row or column via the row and column electrodes 232, 228. At least one row selection electrode 232 is shared by an entire row 220, and at least one column electrode 228 is common to an entire column 224. By selectively driving the various row and column electrodes 232, 228, each optical cell 212 may be accessed.

The optical cells 212 may comprise any suitable systems for selectively providing light. For example, each optical cell 212 may comprise at least one optical element 208, control transistor 206, row transistor 200, 202, 204, and storage capacitor 210. The optical element 208 for each optical cell 212 may comprise any suitable component for selectively transmitting or generating light, such as a light bulb, a light emitting diode (LED), an LC cell in an LC display panel, or an OLED. In the present embodiment, the optical element 208 comprises an OLED, such as a fluorescent or phosphorescent OLED, which generates light according to current through the OLED. The optical element 208 may operate as a binary element (i.e., either on or off), a gray-scale element exhibiting a range of brightness, or a color element exhibiting different colors and brightnesses. In the present embodiment, the OLED operates as a single-color gray-scale element, such that adjusting the current through the OLED controls the brightness of the OLED. In a color display, multiple OLEDs having different colors, such as red, green, and blue OLEDs, may be independently adjusted to achieve desired colors and overall brightness.

The current through the OLED may be controlled to adjust the brightness. The current may be controlled using any appropriate current control system or mechanism, such as a variable resistance, a modulator, an amplifier, or other suitable system. For example, the OLED of the present embodiment is suitably connected in series with the control transistor 206, such that the control transistor 206 controls the amount of current through the OLED. In particular, the OLED is suitably connected between the source of the control transistor 206 and ground, while the drain of the control transistor 206 is connected, directly or indirectly, to a power supply 248. Adjusting the conductivity of the control transistor 206 controls the amount of current through the OLED and thus its brightness. In other embodiments using different optical elements 208, any appropriate mechanism may be used to control the current, voltage, or other signal affecting the brightness of the optical cell 212.

The conductivity of the control transistor 206 corresponds to the voltage applied to its gate. The gate voltage is suitably controlled by signals applied via the column electrode 228. Any appropriate technique may be used to apply and hold the desired signal to control the brightness of the optical cell 212, such as a storage element for storing a value, like a memory or a capacitor. In the present embodiment, the storage capacitor 210 is connected to the gate of the control transistor 206 to maintain the voltage applied to the control transistor 206 gate after the desired charge is applied via the column electrode 228. Thus, a desired charge may be stored on the storage capacitor 210 by selectively connecting the storage capacitor 210 and the gate of the control transistor 206 to the column electrode 228 and applying an appropriate signal to the column electrode 228. The charge stored on the storage capacitor 210 sets the control transistor 206 gate-to-source voltage, thus setting the current through the control transistor 206 and optical element 208. The optical cell 212 brightness thus substantially corresponds to the charge placed on the storage capacitor 210.

A signal applied to the column electrode 228 charges or discharges the storage capacitor 210. The signal may be provided to the individual storage capacitors 210 or other storage mechanisms in any appropriate manner, such as controlling the drive signal applied to the column electrode 228 or the connection between the column electrode 228 and the storage capacitor 210. In the present embodiment, the storage capacitor 210 may be selectively connected to the column electrode 228 to vary or maintain the charge on the storage capacitor 210. For example, a row selection transistor 200 selectively connects the control transistor 206 and the storage capacitor 210 to the column electrode 228. Either the drain or the source of the row selection transistor 200 is connected to the column electrode 228, and the other terminal of the row selection transistor 200 is connected to the control transistor 206 gate and the storage capacitor 210. The gate of the row transistor 200 is connected to the row selection electrode 232. To connect the control transistor 206 gates and storage capacitors 210 for each optical cell 212 in a row 220 to their respective column electrodes 228, the row selection electrode 232 is activated. When the row selection electrode 232 is deactivated, the connection between the column electrodes 228 and the node between the storage capacitor 210 and control transistor 206 gate is terminated, leaving the desired charge stored on the storage capacitor 210.

Referring again to FIGS. 1 and 2, the feedback sensor 104 is configured to generate a signal corresponding, directly or indirectly, to the brightness of one or more optical cells 212. Brightness may be measured for any individual optical cell 212 and/or grouping of optical cells 212, such as all optical cells, a row of optical cells, a column of optical cells, an area of optical cells, or individual optical cells. Any suitable technique for measuring brightness may be used, such as directly or indirectly measuring current through the optical element 208, voltage across the optical element 208, luminance from the optical cell 212, heat of the optical element 208, or another signal substantially corresponding or relating to the brightness of the optical cell 212. The feedback signal 105 may be communicated in any suitable manner. The feedback sensor 104 may measure the current flowing in an optical cell 212, and convert the current to a voltage for use by the control circuit 106, or the feedback sensor 104 may measure a voltage and convert it to a current.

The feedback sensor 104 may be implemented in any suitable manner, such as a light sensor, a voltage sensor, a current sensor, or other sensor. In one embodiment, the feedback sensor 104 measures electrical characteristics, such as a current through the optical element 208 or a voltage across the optical element 208. For example, referring to FIG. 2, the feedback sensor 104 of the present embodiment suitably comprises a resistor, a diode, or diode-connected transistor connected in series with the optical element 208, such that the current through the feedback sensor 104 substantially corresponds to the current through the optical element 208. The feedback sensor 104 of the present embodiment suitably comprises a resistor having a relatively low resistance so that the connection and disconnection of the feedback sensor 104 to the various optical cells 212 does not significantly affect the signal provided to the optical cells 212. Enabling the row selection electrode 232 activates a measurement selection transistor 202, and disabling a row maintenance electrode 230 disables a maintenance transistor 204, directing current to flow from supply 248 through the feedback sensor 104, the measurement selection transistor 202, the control transistor 206, and the optical element 208. The voltage drop across the feedback sensor 104 is substantially proportional to the current through the OLED, which corresponds to the OLED brightness.

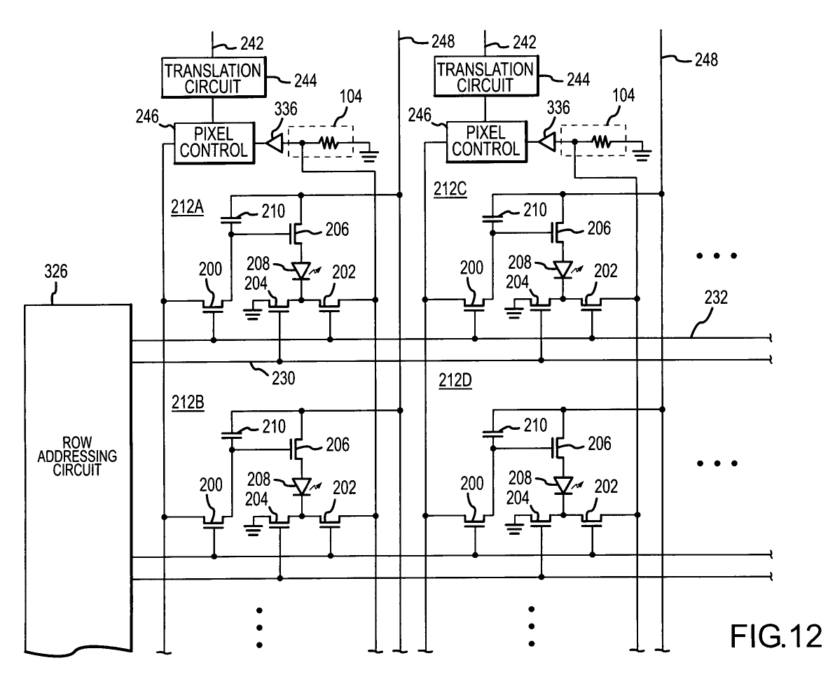

The control transistor 206 may be configured to operate in the saturation region or the subsaturation region. Operation in the saturation region tends to simplify the operating requirements, for example by allowing a relatively large resistor to be used as the feedback sensor 104. Operating the control transistor 206 in the subsaturation region, however, decreases power consumption. The display system 100 may be configured to facilitate operation of the control transistor 206 in the subsaturation region. For example, referring to FIG. 12, the feedback sensor 104 may comprise a low value resistor. The feedback signal 105, which may be as low as a fraction of a millivolt, may be amplified by an amplifier 336 for the pixel control circuit 246. Amplifier 336 may be implemented in any suitable manner, such as a single amplifier, multiple amplifiers in series, or amplifiers integrated into the pixel control circuit 246.

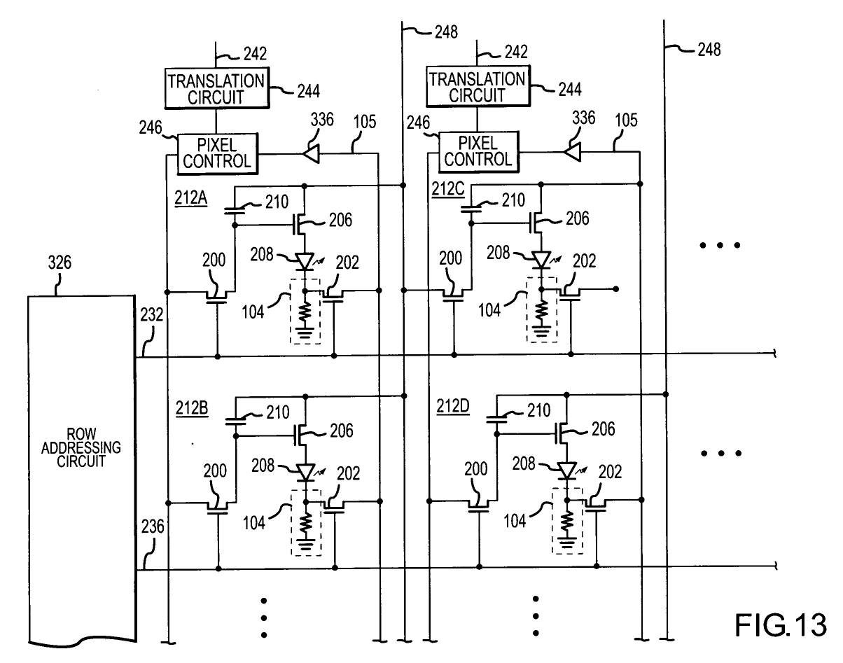

In an alternate subsaturation operation embodiment, referring to FIG. 13, each optical cell 212 may be associated with a dedicated feedback sensor 104 comprising a low-value resistor, instead of having a single resistor or other feedback sensor 104 for an entire column. Disabling the row selection electrode 232 isolates the storage capacitor 210 from the column electrode 228 and disconnects the feedback sensor 104 from the pixel control circuit 246. The resistor may be placed anywhere in the circuit branch where the current related to brightness of the optical cell 212 flows. For example, the resistor may be connected between the cathode of the optical element 208 and source of the control transistor 206, which may facilitate fabrication of the resistors using thin film technology on top of the individual cathodes.

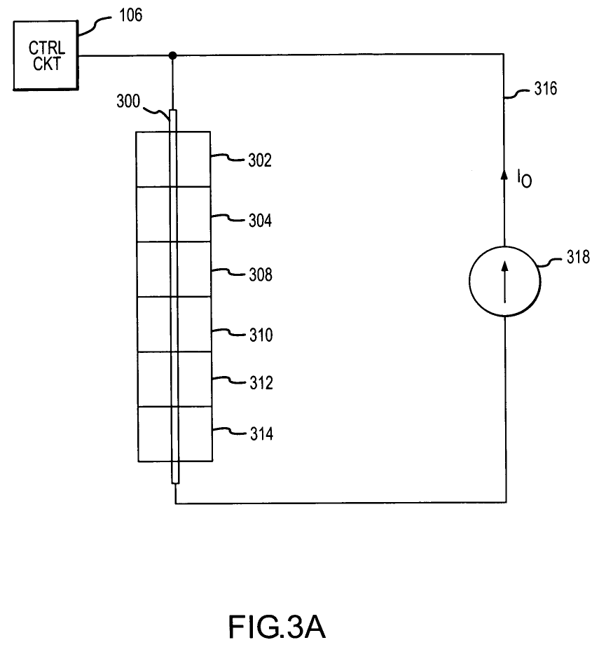

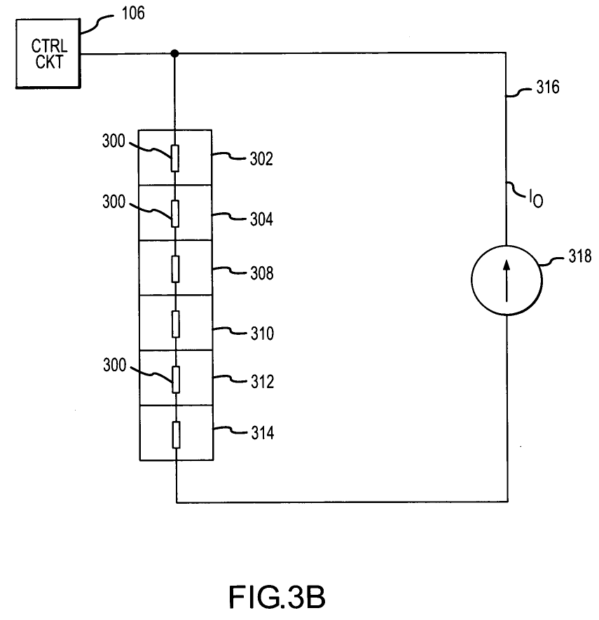

In another exemplary embodiment, the feedback sensor 104 measures optical characteristics of the optical cells 212. For example, referring to FIG. 3A, the feedback sensor 104 may comprise a photo resistor 300. The photo resistor 300 is deposited over any suitable number of optical cells 212, such as an individual optical cell 212 or a row 220 or a column 224 of optical cells 212. The photo resistor 300 is deposited in any suitable manner to allow the photo resistor 300 to detect the luminance from each optical cell 212 with minimal interference with viewing the optical cell 212. For example, a narrow photo resistor 300 may be deposited over a column of optical cells 302, 304, 306, 308, 310, 312, 314. In an alternative embodiment, the feedback sensor 104 may comprise multiple photo resistors dedicated to one or a few pixels. For example, referring to FIG. 3B, the feedback sensor 104 may comprise multiple photo resistors 300, each of which is suitably dedicated to a single optical cell 212. The photo resistors 300 may be positioned in any suitable position to measure the brightness of the optical cell 212, such as over the optical element 208 or along the edge of the optical cell 212. In the present embodiment, the photo resistors 300 are connected in series.

The resistance of the photo resistor 300 is substantially inversely proportional to the brightness of each optical cell 302-314. Consequently, the electrical characteristics of the photo resistor 300 may be measured to determine the brightness of the pixels. For example, a constant current source 318 is suitably connected to the photo resistor 300. The current source 318 drives a constant current through the photo resistor 300, causing the voltage on a measurement electrode 316 to vary substantially proportionally to the resistance in the photo resistor 300. As the brightness of each individual optical cell 302-314 is adjusted, the voltage on the measurement electrode 316 across the photo resistor 300 varies accordingly and thus generates the feedback signal 105. The sensitivity of the sensor 104 can be enhanced by increasing the constant sensor current, which also increases the incremental voltage change corresponding to a brightness change. The sensor current may be increased without influencing the operation of other systems, as the sensor has no electronic connection to other circuits.

The control circuit 106 adjusts optical cell 212 brightness in conjunction with the feedback signal 105. In addition, the control circuit 106 may receive the display information and provide drive signals to drive the display panel 102. Any suitable control circuit 106 may be used to receive display information and control optical cell 212 brightness, such as conventional analog and/or digital circuits. In the present embodiment, the control circuit 106 suitably comprises an integrated circuit for driving the display panel 102 according to the received display information. The control circuit 106 suitably receives display information, determines the target brightness for each relevant optical cell 212 based on the display information, adjusts optical cell 212 brightness, and uses the feedback signal 105 to determine when the selected optical cell 212 reaches the target brightness.

Referring again to FIG. 2, a control circuit 106 according to various aspects of the present invention comprises a translation circuit 244 and a pixel control circuit 246. The translation circuit 244 translates the display information into a target value corresponding to a desired brightness or corresponding value for an optical cell 212. The pixel control circuit 246 activates the row electrodes 230, 232 for the row 220 of optical cells 212 to be adjusted, and drives the column electrode 228 to change the brightness of the optical elements 208. The feedback sensor 104 monitors optical cell 212 brightness and feeds the brightness information to the pixel control circuit 246. The pixel control circuit 246 substantially maintains the state of the optical cell 212 when it reaches the desired brightness.

More particularly, the translation circuit 244 converts display information into a target value representing desired optical cell 212 brightness. The display information may be received in any suitable manner, such as via a port 242. The,display information may be any suitable type of signal. For example, the display information may include digital signals, analog signals, row and column timing signals, voltages, currents, electromagnetic levels, and/or optical signals. Further, the display information may be of any suitable format, such as broadcast format signals, computer display signals, and the like. In addition, the display information may represent absolute optical cell 212 brightness, the incremental difference between the present and the desired optical cell brightness, or total brightness for a row or a column of optical cells 212 with a variant factor from the total brightness for each optical cell 212. Likewise, the target signal may be of any suitable type, for example a digital or analog signals corresponding to voltage, current, luminance, or heat. In the present embodiment, the target value is expressed as an analog voltage value to be compared to the voltage signal generated by the feedback sensor 104.

The translation circuit 244 may generate target values corresponding directly to the display information, such that if the display information calls for a first pixel brightness that is twice as bright as a second pixel brightness, the target value for the first pixel brightness is about twice the target value for the second pixel brightness. Alternatively, the translation circuit 244 may be configured to generate target values for incremental changes. The translation circuit 244 may use any suitable technique to translate the display information into the target value. For example, the translation circuit 244 may comprise a lookup table, a signal processor, a microprocessor, digital logic gates or arrays (synchronous or otherwise), and/or an analog signal processor. The translation circuit 244 may also include storage capacity to store display information or target signal values. Any suitable type and size of storage may be used, and the information stored may be for immediate or later use.

The translation circuit 244 may also perform calculations to determine the target value based on the display information. For example, the translation circuit 244 may convert the display information from a current to a voltage, or a voltage to a luminance. In an alternative embodiment, the translation circuit 244 may store the current flowing through each optical element 208 and may store the display data before converting the information.

Referring to FIG. 2, in the present control circuit 106, the translation circuit 244 includes a look-up table to translate display information into a target value. The look-up table generates predetermined target values, such as target voltages, to drive the display panel 102 and achieve the desired image effects from the received display information. The target values are provided to the pixel control circuit 246 for control of the optical cells 212 in conjunction with the feedback signal 105.

The pixel control circuit 246 adjusts optical cell brightness. The pixel control circuit 246 may adjust the optical cell brightness according to any appropriate mechanism and/or process. For example, the pixel control circuit 246 may adjust the voltage across, the current through, or the temperature of the optical elements 208. The pixel control circuit 246 may simultaneously adjust any suitable number of optical cells 212, such as a single optical cell 212, one optical cell 212 in each column 224, all optical cells 212 of a row 220, all optical cells 212 in a column 224, or all optical cells 212.

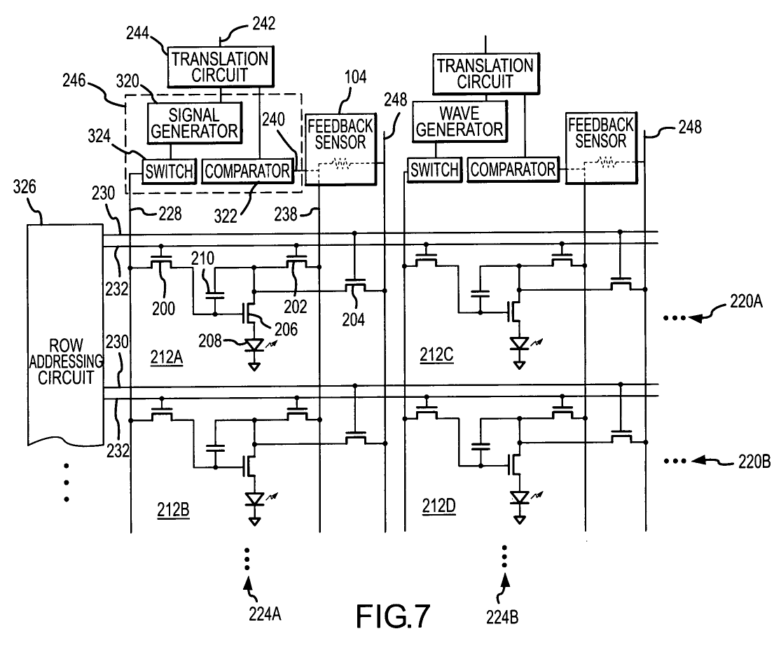

The pixel control circuit 246 is suitably configured to adjust the optical cell 212 brightness according to the target values received from the translation circuit 244 and the feedback signal 105, and may be configured in any suitable manner to control the optical cell 212 brightness. For example, referring to FIG. 7, the pixel control circuit 246 of the present embodiment comprises a variable signal generator 320, a comparison circuit 322, a switch 324, and a row addressing circuit 326. The row addressing circuit 326 controls the row electrodes 230, 232. The variable signal generator 320 generates a variable signal that may be applied to the column electrodes 228 to adjust the brightness of the optical cells 212. The comparison circuit 322 compares the feedback signal 105 to the target value. When the target value is reached, the comparison circuit 322 opens the switch 324 to maintain the desired charge on the column electrode 228.

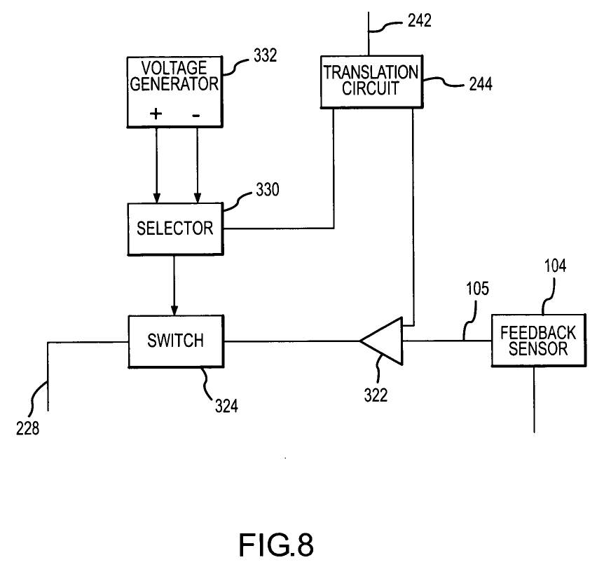

More particularly, the variable signal generator 320 of the present embodiment provides a variable signal through the switch 324 to the column electrode 228 to change the optical cell 212 brightness. The variable signal generator 320 may comprise any suitable system for providing a variable signal. Referring to FIG. 8, the variable signal generator of the present embodiment comprises a selector 330 and a voltage generator 332. The selector 330 selects either an increasing or decreasing signal for application to the column electrode 228. Selecting the increasing signal causes the voltage applied to the column electrode 228 to increase, and vice versa with selecting the decreasing signal. The selector 330 may select the signal to be applied according to any appropriate criteria, such as the relative values of the current target value and the preceding target value or the feedback signal 105 for the relevant optical cell 212.

The voltage generator 332 generates the variable signal that varies in the direction designated by the selector 330. The voltage generator 332 may generate any appropriate waveform or set of waveforms for selection, such as a step voltage, a ramp, a modulated step voltage, a piece-wise linear voltage, a current, or a DC power supply. In one embodiment, the voltage generator 332 produces an increasing step voltage and a decreasing step voltage. In an alternate embodiment, the voltage generator 332 comprises a power sink, such as a low voltage supply, and a power source, such as a high voltage supply, that may be selectively connected to the column electrode by the selector 330 to discharge or charge, respectively, the column electrode 228. In an alternate embodiment, the voltage generator 332 produces increasing and decreasing ramp voltages. Ramp voltages tend to reduce cross talk between the column electrode 228 and the optical cells 212 not selected for adjustment, which tends to increase visual quality.

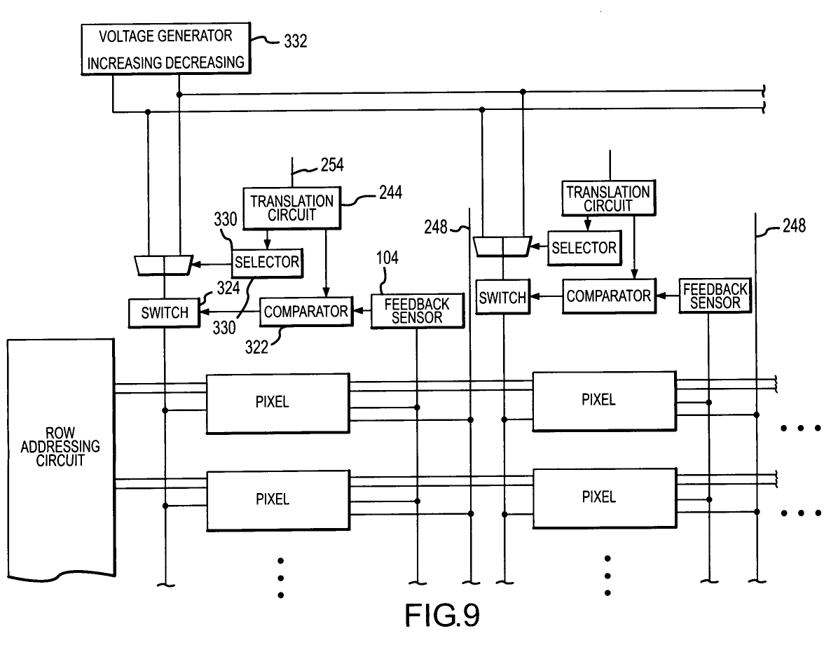

The variable signal generator 320 may be configured in any suitable manner to drive the various electrodes. Referring again to FIG. 7, each column electrode 228 may be associated with a dedicated voltage generator 332. Alternatively, referring to FIG. 9, the voltage generator 332 may be associated with multiple column electrodes 228. A selector 330 unique to each column electrode 228 selects the appropriate signal for adjusting optical cell 212 brightness in the column 224.

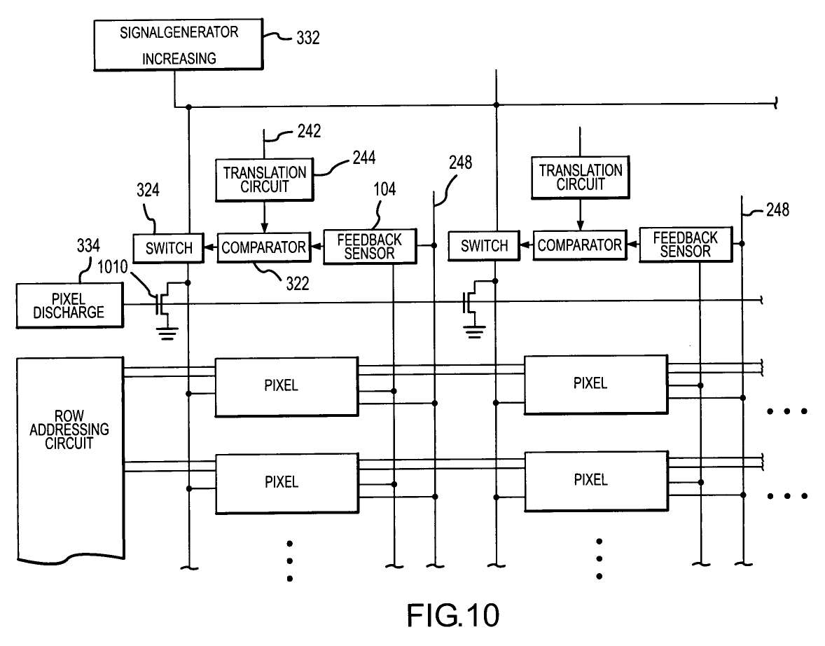

In another embodiment, referring to FIG. 10, the voltage generator 332 produces a signal that only increases or only decreases. Before the variable signal is applied to the column electrode 228, the row addressing circuit 326 initializes the optical cells 212, for example by activating a pixel discharge circuit 334 to drain the charge from the column electrode 228 and storage capacitor 210 before applying a drive voltage to the column electrode. Conversely, the voltage generator 332 may produce only a decreasing signal, such that the column electrode 228 and storage capacitor 210 are pre-charged to the highest level required for maximum pixel brightness before driving the column electrode 228 with the variable signal.

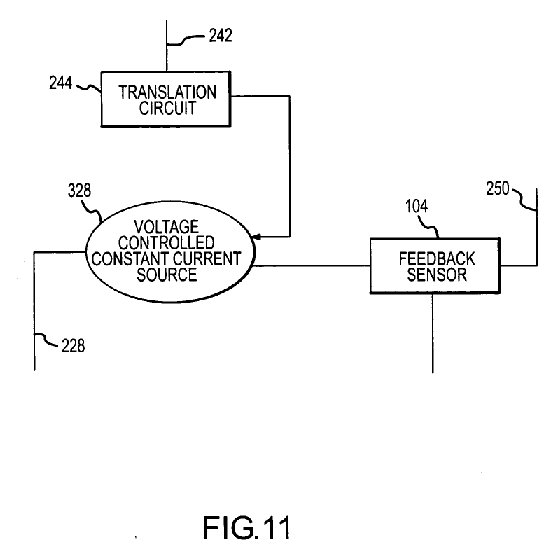

In another embodiment, the variable signal generator 320 may be replaced with a constant current source. Referring to FIG. 11, the current source, such as a voltage-controlled current source 328, supplies a current to the column electrode 228. The current is suitably regulated by a comparison between the feedback signal 105 and the target value, such as using a conventional comparator circuit as the current source 328. In an additional alternative embodiment, the variable signal generator 320 includes a constant current source and sink. The selector 330 selects the current source or sink required to properly adjust the optical cell brightness.

The pixel control circuit 246 is configured to determine whether the feedback signal 105 has approached the target value, and may include any suitable configuration or element to compare the target value with the feedback signal 105 and control the switch 324. For example, the present pixel control circuit 246 includes the comparison circuit 322 to compare the feedback signal 105 to the target value. The comparison circuit 322 may comprise any suitable system or component for comparing signals, such as a conventional operational amplifier configured as a comparator. In the present embodiment, the comparison circuit 322 compares the target value received from the translation circuit 244 with the feedback signal 105. When the feedback signal 105 is substantially equal to the target value, the comparison circuit 322 disables the switch 324 and isolates the column electrode 228 from the variable signal generator 320. Disabling the switch 324 substantially maintains the voltage on the column electrode 228 at the desired target voltage.

The comparison circuit 322 may also be configured to maintain the brightness for the optical cell. For example, after the initial charging of the storage capacitor 210, the comparison circuit 322 opens the switch 324 to maintain the charge on the storage capacitor 210. In some systems, however, the charge on the storage capacitor 210 may be redistributed from the storage capacitor 210 onto column parasitic capacitances or other unwanted capacitances. Accordingly, the charge on the storage capacitor 210 may drop, causing an undesired loss of brightness.

The comparison circuit 322 may be configured to counteract the redistribution of the charge or other unwanted loss of brightness. For example, the comparison circuit 322 may be configured to exhibit hysteresis, such that the storage capacitor 210 may be charged to an upper threshold beyond the target value, such as a percentage or preselected amount more than the target value, before opening the switch 324. In addition, after the comparison circuit 322 opens the switch 324, the comparison circuit 322 may continue to monitor the feedback signal 105 for the remainder of the row address cycle. If the feedback signal 105 drops below a lower threshold, such as a percentage or preselected difference from the target voltage, the comparison circuit 322 may close the switch 324 to recharge the capacitor 210 and increase the brightness until the upper threshold is again reached. The hysteresis may be symmetrical or non-symmetrical around the target value. Further, the comparison circuit 322 with hysteresis may be used in conjunction with pre-charging or presetting the charge on the storage capacitor 210 to any value before adjusting the optical cell 212 to the desired brightness.

Any suitable system and/or technique may be used to maintain charge on the feedback capacitor 210 between the time that the feedback signal 105 reaches the target value and completion of the row address cycle, at which time the row electrode 232 is disabled. For example, the variable signal generator 320 and the current source 328 may be configured to selectively operate sequentially or simultaneously in parallel. The signal generator 320 may perform fast charging of the capacitor 210, while the current source 328 suitably adjusts for small deviations from the target voltage.

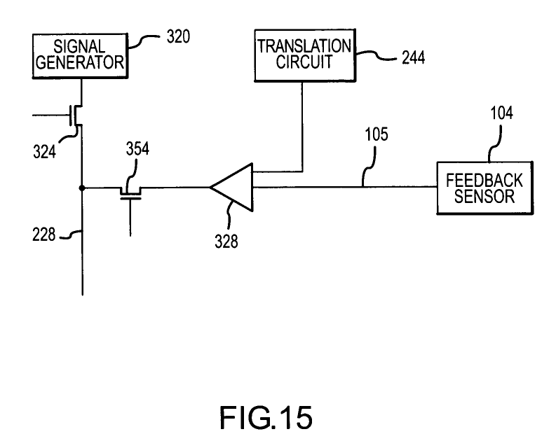

In one embodiment, referring to FIG. 15, the variable signal generator 320 drives the column electrode 228 through the switch 324 until the feedback signal 105 is substantially equal to the target value. As soon as the feedback signal 105 is equal to the target value, the switch 324 is opened and a second switch 354 is closed. Closing the second switch 354 enables the current source 328 to drive the column electrode 228 whenever the feedback signal 105 is not equal to the target value. The current source 328 maintains the column electrode 228 and storage capacitor 210 at the target value until the end of the row address cycle for the row and the row electrode 232 is deactivated. The current source 328 compares the target value with the feedback signal 105 and charges and discharges the column electrode 228 to maintain the desired charge on the storage capacitor 210. The current source 328 may be implemented using any suitable circuit; for example, it may have multiple stages to provide greater gain or drive strength.

In an additional alternative embodiment, the pixel control circuit 246 is configured to quickly charge or discharge the column electrode 228 by using both the variable signal generator 320 and the difference amplifier 356 to drive the column electrode 228 simultaneously until the feedback signal 105 is equal to the target value. Once the feedback signal 105 reaches the target value, the first switch 324 is opened to disconnect the variable signal generator 320 from the column electrode 228, while the second switch 354 remains closed (or is omitted altogether, for example if the signal from the variable signal generator 320 does not adversely affect the current source 328), so the current source 328 maintains the charge on the storage capacitor 210 until the row addressing cycle for the row is complete.

The switch 324 selectively connects the column electrode 228 to the variable signal generator 320 or other power source. The switch 324 may comprise any suitable system for selectively enabling and disabling the connection, such as a relay, a switch, a transistor, and the like. In the present embodiment, the switch 324 comprises a transistor where the source or drain is connected to the variable signal generator 320, the opposite terminal is connected to the column electrode 228, and the gate is driven by the comparison circuit 322 output. When the switch 324 is opened, the variable signal generator 320 is disconnected from the column electrode 228. When the switch 324 is closed, the signal from the variable signal generator 320 drives the column electrode 228.

The row addressing circuit 326 selects a row 220 of optical cells 212 for brightness adjustment. Any suitable technique may be used for controlling the order and the method of row 220 selection, such as selecting an entire row, a fraction of a row, multiple rows, or multiple fractions of different rows. For example, referring again to FIG. 7, each row may be addressed using the row selection electrode 232 and the row maintenance electrode 230. The row selection electrode 232 controls connection of the optical cell 212 to the column electrode 228 and the feedback sensor 104. The row maintenance electrode 230 controls connection of the optical cell 212 to the power supply while bypassing the feedback sensor 104. When the row selection electrode 232 is active, the optical cells 212 in the corresponding row 220 may be adjusted. When the row selection electrode 232 is inactive, the row maintenance electrode 230 is suitably activated to provide power to each optical cell 212 in the row 220. All optical cells 212 of a row 220 are suitably adjusted simultaneously.

By driving the row and column electrodes 228, 230, 232, the control circuit 106 can control the display panel 102, measure the brightness of the individual optical cells 212, and adjust the brightness of the individual optical cells 212. Disabling the row maintenance electrode 230 disables the maintenance transistors 204 for each optical cell 212 in the row. Activating the row selection electrode 232 activates the row selection transistors 200, 202, which connect the control transistor 206 to the column electrode 228 and the power supply via the feedback sensor 104, respectively. Thus, the brightness of each optical element 212 may be adjusted by driving the column electrode 228 with the appropriate signal and monitoring the optical cell 212 brightness via the feedback sensor 104. The comparison circuit 322 detects when the current through the control transistor 206 and optical element 208 reaches the target value and opens the switch 324 to maintain the charge on the storage capacitor 210. When the row addressing cycle is complete, the row selection electrode 232 is disabled to inhibit further modification of the current through the optical cell 212. Further, row maintenance electrode 230 is enabled to connect the control transistor 206 and optical element 208 to the supply 248 through the maintenance transistor 204.

In an alternative embodiment, the row selection and maintenance system may be configured to facilitate the use of a single row electrode 232 for each row 220. Instead of connecting the feedback sensor 104 to each individual optical cell 212 in the column 228, the feedback sensor 104 may remain connected to multiple optical cells 212 in the column 224. To compare the feedback signal 105 to the target value, the pixel control circuit 246 suitably compares the target value to the change in the feedback signal 105 attributable to the relevant optical cell 212. Various aspects previously discussed may be applied to the present embodiment as well, such as multiple or single signal generators, operation of the control transistor in subsaturation region, different placements of the sensor 105, and the like.

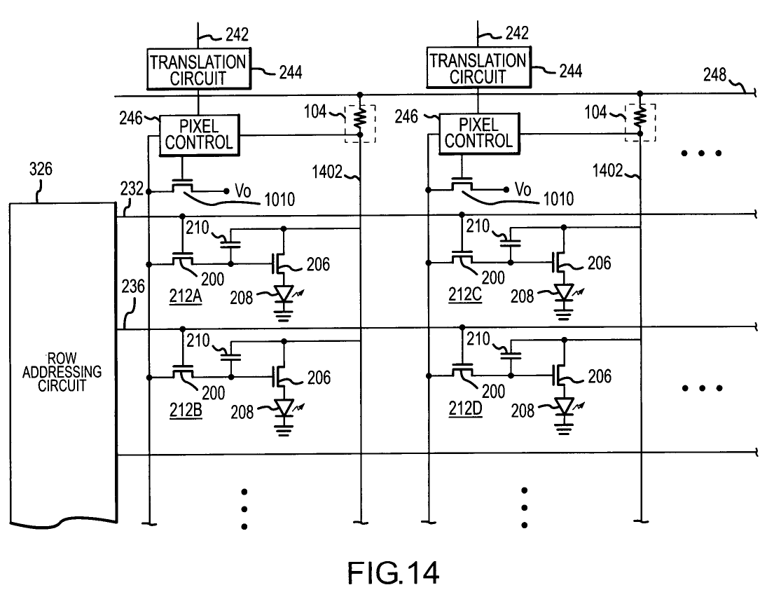

For example, referring to FIG. 14, a single row electrode 232 controls connection of the control transistors 206 and storage capacitors 210 in the row to their respective column electrodes 228. The feedback sensor 104 comprises a column sensor that is connected to each control transistor 206 in the column, for example via a power electrode 1402. The brightness of each optical cell 212 may be adjusted by activating the row electrode 232 and driving a signal on the column electrode 228. The feedback signal 105 comprises a brightness sum signal comprising the currents for all of the optical cells 212 in the column, and the brightness sum signal varies as the conductivity of the control transistor 206 in the relevant row changes. As each optical cell 212 is adjusted for each row, the feedback signal 105 changes, such that the feedback signal 105 comprises a sequential signal corresponding to varying brightnesses of multiple optical cells in the column. By monitoring the amount of change in the feedback signal 105 for each optical cell 212, the control circuit 106 may control the brightness of each optical cell 212 in the column.

Current from multiple optical cells 212 continuously flows through the feedback sensor 104 and a brightness change of the optical cell 212 results in an incremental change in the feedback signal 105. When the target value is reached, the pixel control circuit 246 terminates the connection to the variable signal generator 320. The row electrode 232 is disabled at the end of the row address cycle, deactivating the row transistor 200 and isolating the storage capacitor 210.

The change in the feedback signal 105 and/or target value may be measured and/or calculated according to any suitable technique or mechanism. For example, the target value may be calculated in the translation circuit 244 by summing or otherwise summarizing the target values for all of the other optical cells 212 in the column at the beginning of the row address cycle, and adjusting the summary number according to the current target value for the current optical cell 212 to determine an overall target value for the entire column.

For example, the preceding target value for a first row address cycle may be stored, and then retrieved and subtracted from the current target value for a second row address cycle. The resulting value corresponds to the desired change in the feedback signal 105 for the relevant optical cell 212. Alternatively, the control circuit 106 may store the an initial feedback signal 105 for a first row address cycle, and then subtract the initial feedback signal 105 value from the current target value from a second row address cycle to arrive at a desired change in the feedback signal 105. The pixel control circuit 246 may then monitor the feedback signal 105 for the desired change and control the control transistor 206 and storage capacitor 210 accordingly.

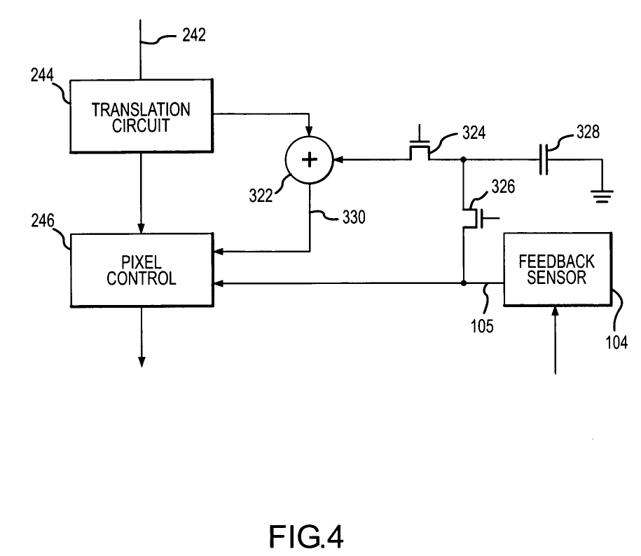

Referring to FIG. 4, in an exemplary embodiment, the pre-adjustment feedback signal 105, meaning the feedback signal 105 before responding to the current display information, of the selected optical cell 212 may be stored on a storage capacitor 328 as a reference voltage by activating a storage transistor 326. The translation circuit 244 converts the current display information into a target voltage change attributable to the optical cell 212 in the row being addressed. The storage transistor 326 is deactivated and a sum transistor 324 is activated, such that the charge on the capacitor 328 is provided to a summing circuit 322. The summing circuit 322 adds the current target value change to the previous feedback signal 105 value stored on the capacitor 328. The resulting sum is the target value used by the pixel control circuit 246 to adjust the optical cell 212 brightness.

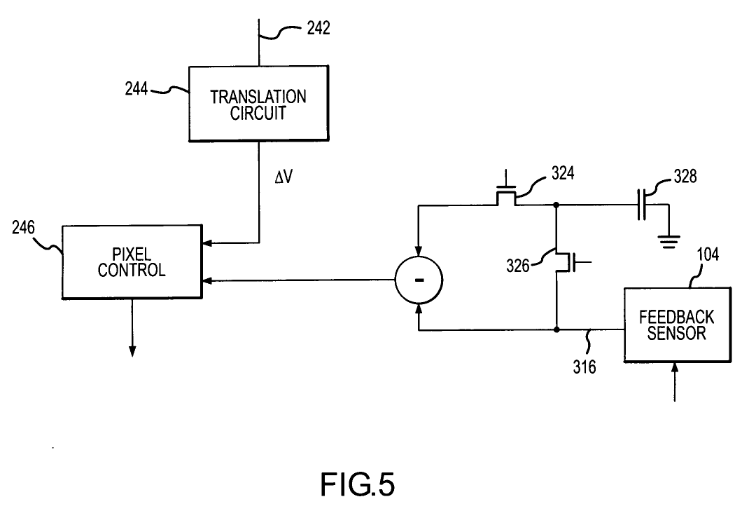

In another alternative embodiment, referring to FIG. 5, the pre-adjustment voltage is stored on the capacitor 328. The translation circuit 244 provides the pixel control circuit 246 with its calculated incremental change value as the target value. The pre-adjustment value stored on the capacitor 328 is subtracted from the feedback signal 105 to produce an incremental change from the feedback sensor 104. When the feedback signal 105 changes by the target incremental amount, the optical cell 212 under adjustment has reached the desired brightness.

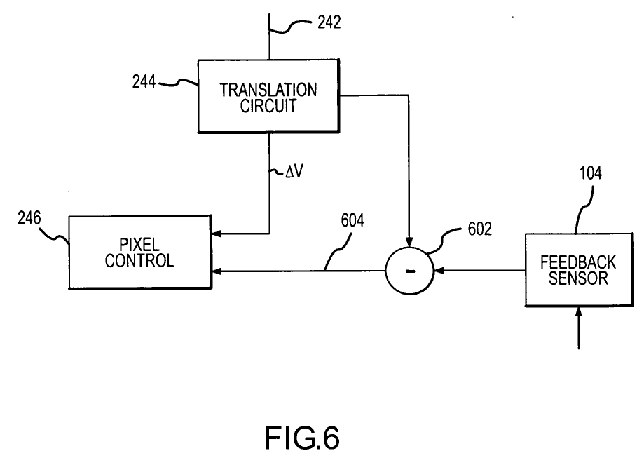

In yet another alternative embodiment, referring to FIG. 6, the translation circuit 244 uses stored information to calculate the pre-adjustment value, and calculates a current target value based on the display information. The translation circuit 244 subtracts the pre-adjustment value from the target value to find the incremental change value. The translation circuit 244 provides the incremental change value to the pixel control circuit 246 and the pre-adjustment value to a difference circuit 602 so that the signal 604 provided to the pixel control circuit 246 is also an incremental change value. When the feedback signal 105 changes by the same amount as the target incremental change value, the optical cell 212 has been adjusted properly.

Alternatively, the translation unit 244 may store the display information and determine the pre-adjustment value of the voltage across the feedback sensor 104. Transistor 326 is closed to store the pre-adjustment voltage value of the feedback sensor 104 on capacitor 328. The translation unit 244 calculates a new target voltage across the feedback sensor 104 according to the display information. The translation unit 244 subtracts the pre-adjustment value from the target voltage to produce an incremental change value. Transistor 326 is opened, transistor 324 is closed, and the incremental change value is summed with pre-adjustment value stored on capacitor 328 to produce the target value used by the pixel control circuit 246.

In another alternative embodiment, the translation circuit 244 stores the current flowing in each optical element 212. Before adjusting a particular optical cell 212, the translation circuit 244 stores an updated target current value for the optical cell 212 for the current row address cycle. The translation circuit 244 then sums all the stored current values and calculates the target voltage across the feedback sensor 104. The calculated voltage value becomes the target value and is used by the pixel control circuit 246 to adjust the optical cell 212 to the correct brightness.

A feedback sensor 104 that measures the current through multiple pixels may have a large absolute voltage difference between its all-off and all-on values. The pixel control circuit 246 must respond to the voltage levels provided by both the translation circuit 244 and the feedback sensor 104. Using an incremental change in voltage instead of the absolute voltage directly from the feedback sensor 104 tends to allow the pixel control circuit 246 to work at a lower voltage and consume less power.

Several implementations derive the current target value from the pre-adjustment value, including the preceding value in the optical cell 212 for which the brightness is updated. The values may accumulate errors during the frame time, such as errors from electromagnetic interference, capacitive coupling, and parasitic discharge of the capacitor 210. To reduce such errors, the control voltage stored on the capacitor 210 may be initialized to a known value, such as discharged to zero, by activating the pixel discharge circuit 334 to close the switch 1010 (FIG. 10). Initializing the charge on the storage capacitor 210 facilitates charging the capacitor 210 to the desired target value independent of the previous, possibly erroneous, value, which tends to suppress propagation of errors from frame to frame. The pixel discharge may reduce errors when using both electrical sensors (such as resistors) and optical sensors (such as photo resistors).

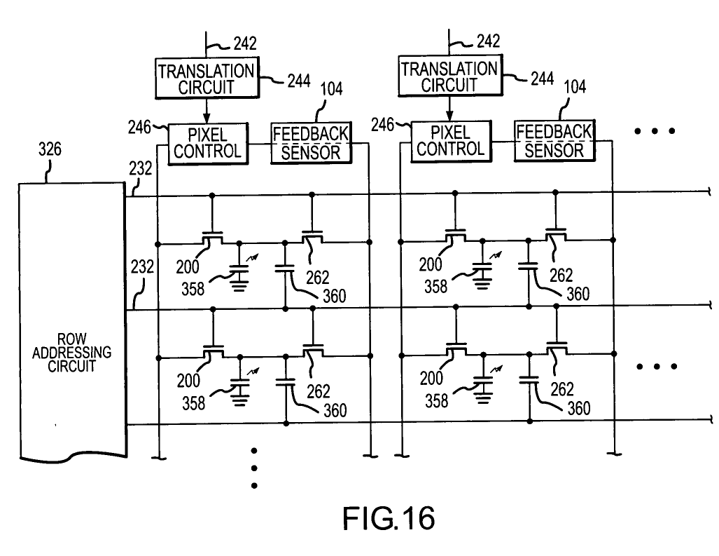

A display system 100 may be implemented in conjunction with an LCD panel and other types of displays. Various aspects previously described are equally applicable and adaptable for LCD implementations. .For example, referring to FIG. 16, an exemplary LCD panel 102 includes rows and columns of LC optical cells controlled by the control circuit 106 in conjunction with the feedback sensor 104. The control circuit 106 may comprise any suitable control circuit, such as a control circuit 106 comprising the pixel control circuit 246 and the translation circuit 244. The translation circuit 244 converts display information into target values. The pixel control circuit 246 selects optical cells 212 and manipulates the appropriate column electrodes 228 to adjust brightness. The feedback sensor 104 monitors the effects of the adjustments and reports to the pixel control circuit 246. When the pixel brightness, as reported by the feedback signal 105, reaches the desired brightness as specified by the target value, the pixel control circuit 246 stops the adjustment process.

Unlike current driven optical elements 208 like OLEDs, the brightness of a LC optical element corresponds to the voltage across the LC cell 358. To generate the feedback signal 105, the feedback sensor may comprise a node connected to one or more LC cells to monitor the voltage applied to the LC cells. The node may be connected to the pixel control circuit 246 to provide the feedback signal 105.

A display system 100 according to various aspects of the present invention may also implement a fast addressing process to promote fast response of the LC material.

Fast addressing may be applicable for several environments, such as for panels with a large number of rows, like in a television panel with 1000 rows. With so many rows, the row address time is very short.

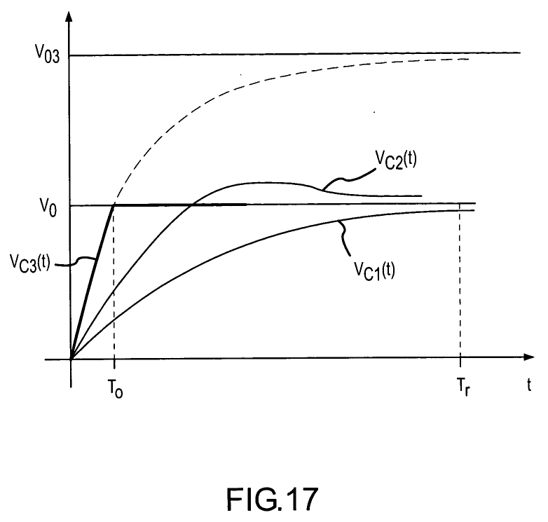

Fast addressing may be facilitated by overdriving (i.e., providing a significantly higher magnitude signal than the intended maximum voltage) the signals applied across the liquid crystal. Referring to FIGS. 16 and 17, a non-overdrive signal applied across the LC cell 358 charges with the time constant T converging to the voltage Vo provided by the column line 228 (V_{c1}(t)). The charging is sufficient if the target voltage across 358 is about 3% lower than Vo, while fully charging to Vo would require an infinite time. To speed up the charging, the control circuit 106 may apply larger voltages, such that the voltage across the LC cell 358 more quickly reaches the target voltage Vo. In the present embodiment, an overdrive voltage is applied across the LC cell 358, causing the voltage to rise quickly. The feedback signal 105 indicates the time at which the desired voltage across the LC cell 358 (V_{c3}(t))has been achieved, and terminates further charging across the LC cell 358.

The display system 100 according to various aspects of the present invention provides for monitoring the brightness of individual pixels and dynamically, automatically adjusting the brightness to achieve the desired brightness, regardless of the age or operating characteristics of the optical element 208. Any suitable method may be used to monitor and adjust optical cell brightness. In the present embodiments, the display information is received from a source, for example data for a frame. The display information suitably contains brightness information for each optical element 208 in the display system 100.

The translation circuit 244 translates the display information into target values corresponding to the desired brightness or change in brightness of each optical cell 212, such as a target current through an OLED required to achieve the desired brightness, a target voltage across an LC cell required to transmit the desired intensity of light, or a feedback sensor voltage from a photosensor corresponding to the desired brightness. The target values are provided to the pixel control circuit 246 to drive the display panel 102, for example as a sequence of lines corresponding to data for each row in the frame.

The pixel control circuit 246 drives each pixel in the row of the display panel 102 and monitors the feedback signal 105. For each optical cell 212 in the row, the selector 330 compares the target value with a preceding value, such as the preceding target value or the feedback signal 105 for the relevant optical cell from the preceding frame. The selector then provides either an increasing or a decreasing signal to the optical cell 212 via the column electrode 228. Alternatively, the pixel control circuit 246 may initialize the optical cell to a known state, such as fully charged or fully discharged, and then provide a decreasing signal or an increasing signal to the optical cell 212. The optical cells 212 are addressed by activating the appropriate row selection electrode 232 to connect the column electrode 228 to the optical cells 212. If necessary, the feedback sensor 104 may also be connected to the optical cell, for example by deactivating row maintenance electrode 230.

As the variable signal is applied to the optical cell 212, the brightness changes, causing a corresponding change in the feedback signal 105. The pixel control circuit 246 compares the feedback signal 105 to the target value and adjusts the signal provided to the optical cell 212 so that the brightness is maintained at the desired level. The pixel control circuit 246 may continue to monitor the brightness via the feedback signal 105 to maintain the desired brightness for the remaining portion of the row address cycle. At the end of the row address cycle, the row electrode is deactivated, leaving the optical cell 212 at the desired brightness. If appropriate, the feedback sensor 104 may be disconnected from the optical cell 212 as well and power may be provided via an alternate route, such as by activating the row maintenance electrode.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The present invention has been described above with reference to a preferred embodiment. However, changes and modifications may be made to the preferred embodiment without departing from the scope of the present invention. These and other changes or modifications are intended to be included within the scope of the present invention.

1. A brightness control circuit for controlling the brightness of an optical cell, comprising:
a sensor configured to provide a signal corresponding to the brightness of the optical cell;
a control circuit connected to the optical cell and configured to adjust the brightness of the optical cell according to the sensed brightness of the optical cell.

2. A brightness control circuit according to claim 1, wherein:
the control circuit includes a comparison circuit to compare the brightness signal to a target value; and
the control circuit is configured to stop adjusting the brightness of the optical cell when the comparison circuit indicates that the brightness signal is within a selected range of or identical to the target value.

3. A brightness control circuit according to claim 2, wherein the control circuit further comprises an amplifier connected between the comparison circuit and the sensor and configured to amplify the brightness signal.

4. A brightness control circuit according to claim 1, wherein the control circuit is configured to overdrive the optical cell.

5. A brightness control circuit according to claim 1, wherein:
the control circuit comprises a variable signal source to provide a varying signal to the optical cell to adjust the optical cell brightness; and
the varying signal comprises at least one of an increasing and a decreasing ramp voltage.

6. A brightness control circuit according to claim 1, wherein:
the control circuit comprises a variable signal source to provide a varying signal to the optical cell to adjust the optical cell brightness; and
the varying signal comprises at least one of an increasing and a decreasing step voltage.

7. A brightness control circuit according to claim 1, wherein:
the control circuit comprises a current source to provide a current to the optical cell to adjust the optical cell brightness; and
the current source provides a current according to a difference between the brightness signal and a target value.

8. A brightness control circuit according to claim 1, wherein the control circuit includes:
a variable signal generator selectively connectable to the optical cell to provide a varying signal to the optical cell to adjust the optical cell brightness; and
a current source selectively connectable to the optical cell to provide a current to the optical cell to adjust the optical cell brightness.

9. A brightness control circuit according to claim 8, wherein the variable signal generator and the current source are selectively simultaneously connectable to the optical cell.

10. A brightness control circuit according to claim 1, wherein the sensor includes a resistor connected to the optical cell to sense the current provided to the optical cell.

11. A brightness control circuit according to claim 1, wherein the sensor includes a resistor connected between the optical cell and the control circuit.

12. A brightness control circuit according to claim 1, wherein the sensor includes a resistor connected between the control circuit and ground.

13. A brightness control circuit according to claim 1, wherein the optical cell includes a control transistor configured to control the brightness of the optical cell, and wherein the control transistor is configured to operate in a subsaturation region.

14. A brightness control circuit according to claim 1, wherein the sensor includes a resistor configured to be selectively connected to multiple optical cells.

15. A brightness control circuit according to claim 1, wherein:
the sensor includes a resistor connected to an optical element in the optical cell; and
the resistor is configured to be selectively connected to the control circuit.

16. A brightness control circuit according to claim 15, wherein:
the optical cell includes an OLED; and
the resistor is connected between at least one of (a) a cathode of the OLED and the source of a thin film transistor and (b) an anode of the OLED and ground.

17. A brightness control circuit according to claim 1, wherein the sensor includes:
a variable resistor, wherein the resistance of the variable resistor corresponds to the combined brightnesses of multiple optical cells; and
a current source connected to the variable resistor to provide a current to the variable resistor;
wherein the current source supplies only the variable resistor, the brightness signal includes a voltage across the variable resistor, and a sensitivity of the sensor may be increased by increasing the current provided by the current source.

18. A brightness control circuit according to claim 1, wherein the control circuit is configured to set the optical cell to a substantially known brightness before adjusting the brightness of the optical cell according to the sensed signal.

19. A brightness control circuit according to claim 1, wherein:
the optical cell includes a capacitor for storing a charge corresponding to the brightness of the optical cells; and
the control circuit is configured to discharge the capacitor to a substantially known charge before adjusting the brightness of the optical cell according to the sensed signal.

20. A brightness control circuit according to claim 1, wherein the control circuit is further configured to substantially maintain the adjusted brightness of the optical cell according to the sensed signal for a remaining duration of a row address cycle.

21. A brightness control circuit according to claim 1, wherein the control circuit:
includes a comparison circuit to compare the sensed brightness to a target value; and
the control circuit is configured to maintain the brightness of the optical cell within a selected range of or identical to the target value.

22. A brightness control circuit according to claim 1, wherein the control circuit:
includes a power source and a power sink; and
is configured to adjust the brightness of the optical cell according to the sensed signal by selectively connecting the optical cell to the power source and the power sink.

23. A brightness control circuit according to claim 1, wherein:
the sensor senses a first signal corresponding to a brightness of a first optical cell and a second signal corresponding to the brightness of a second optical cell; and
the control circuit independently adjusts the brightness of the first optical cell according to the first signal and the brightness of the second optical cell according to the second signal.

24. A brightness control circuit according to claim 1, wherein the optical cell comprises a liquid crystal cell.

25. A brightness control circuit according to claim 24, wherein the sensor comprises a node connected to an electrode of a liquid crystal cell.

26. A brightness control circuit according to claim 1, wherein:
multiple optical cells are configured in multiple columns and multiple rows; and
the control circuit includes a variable signal source to simultaneously provide a varying signal to the optical cells in multiple columns to adjust the individual brightnesses of the optical cells.

27. A brightness control circuit according to claim 1, wherein:
multiple optical cells are configured in multiple columns and multiple rows;
the sensor includes a column sensor connected to a column of optical cells, wherein the sensor is configured to sense a sequential signal corresponding to brightnesses of multiple optical cells in the column.

28. A brightness control circuit according to claim 1, wherein:
multiple optical cells are configured in multiple columns and multiple rows;
the sensor includes a column sensor connected to a column of optical cells, wherein the sensor is configured to sense a brightness sum signal corresponding to the sum of the brightnesses of multiple optical cells in the column.

29. A brightness control circuit according to claim 28, wherein the control circuit is configured to determine the brightness of a single optical cell in the column of optical cells according to a change in the brightness sum signal.

30. A brightness control circuit according to claim 1, wherein:
multiple optical cells are configured in multiple columns and multiple rows;
the sensor includes a light sensor responsive to multiple optical cells in a column; and
the light sensor provides a brightness sum signal corresponding to the sum of the brightnesses of the multiple optical cells in the column.

31. A display, comprising:
a display panel having multiple optical cells;
a sensor configured to sense a signal corresponding to a brightness of at least one of the optical cells; and
a control circuit connected to the at least one of the optical cells and the sensor, wherein the control circuit is configured to adjust the brightness of the at least one of the optical cells according to the sensed signal.

32. A display according to claim 31, wherein the control circuit:
includes a comparison circuit to compare the sensed brightness to a target value; and
is configured to stop adjusting the brightness of the at least one of the optical cells when the comparison circuit indicates that the sensed brightness is within a selected range of or identical to the target value.

33. A display according to claim 32, wherein the control circuit further comprises an amplifier connected between the comparison circuit and the sensor and configured to amplify the sensor signal.

34. A display according to claim 31, wherein the control circuit is configured to overdrive the at least one of the optical cells.

35. A display according to claim 31, wherein:
the control circuit includes a variable signal source to provide a varying signal to the at least one of the optical cells to adjust the brightness of the at least one of the optical cells; and
the varying signal comprises at least one of an increasing and a decreasing ramp voltage.

36. A display according to claim 31, wherein:
the control circuit comprises a variable signal source to provide a varying signal to the at least one of the optical cells to adjust the brightness of the at least one of the optical cells; and
the varying signal comprises at least one of an increasing and a decreasing step voltage.

37. A display according to claim 31, wherein:
the control circuit comprises a current source to provide a current to the at least one of the optical cells to adjust the brightness of the at least one of the optical cells; and
the current source provides the current according to a difference between the sensed brightness signal and a target value.

38. A display according to claim 31, wherein the control circuit includes:
a variable signal generator selectively connectable to the at least one of the optical cells to provide a varying signal to the at least one of the optical cells to adjust the brightness; and
a current source selectively connectable to the at least one of the optical cells to provide a current to the at least one of the optical cells to adjust the brightness.

39. A display according to claim 38, wherein the variable signal generator and the current source are selectively simultaneously connectable to the at least one of the optical cells.

40. A display according to claim 31, wherein the sensor includes a resistor connected to the at least one of the optical cells to sense the current provided to the at least one of the optical cells.

41. A display according to claim 31, wherein the sensor includes a resistor connected between the at least one of the optical cells and the control circuit.

42. A display according to claim 31, wherein the sensor includes a resistor connected between the control circuit and ground.

43. A display according to claim 31, wherein the at least one of the optical cells includes a control transistor configured to control the brightness of the at least one of the optical cells, and wherein the control transistor is configured to operate in a subsaturation region.

44. A display according to claim 31, wherein the sensor includes a resistor configured to be selectively connected to multiple optical cells.

45. A display according to claim 31, wherein:
the sensor includes a resistor connected to an optical element in the at least one of the optical cells; and
the resistor is configured to be selectively connected to the control circuit.

46. A display according to claim 45, wherein:
the optical cell includes an OLED; and
the resistor is connected between at least one of (a) a cathode of the OLED and the source of a thin film transistor and (b) an anode of the OLED and ground.

47. A display according to claim 31, wherein the sensor includes:
a variable resistor, wherein the resistance of the variable resistor corresponds to the combined brightnesses of multiple optical cells; and
a current source connected to the variable resistor;
wherein the current source supplies only the variable resistor, the sensed signal includes a voltage across the variable resistor, and a sensitivity of the sensor may be increased by increasing the current provided by the current source.

48. A display according to claim 31, wherein the control circuit is configured to set the at least one of the optical cells to a substantially known brightness before adjusting the brightness of the at least one of the optical cells according to the sensed signal.

49. A display according to claim 31, wherein:
the at least one of the optical cells includes a capacitor for storing a charge corresponding to the brightness of the at least one of the optical cells; and
the control circuit is configured to discharge the capacitor to a substantially known charge before adjusting the brightness of the at least one of the optical cells according to the sensed signal.

50. A display according to claim 31, wherein the control circuit is further configured to substantially maintain the adjusted brightness of the at least one of the optical cells according to the sensed signal for a remaining duration of a row address cycle.

51. A display according to claim 31, wherein the control circuit:
includes a comparison circuit to compare the sensed brightness to a target value; and
is configured to maintain the brightness of the at least one of the optical cells within a selected range of or identical to the target value.

52. A display according to claim 31, wherein the control circuit:
includes a power source and a power sink; and
is configured to adjust the brightness of the at least one of the optical cells according to the sensed signal by selectively connecting the at least one of the optical cells to the power source and the power sink.

53. A display according to claim 31, wherein:
the sensor senses a first signal corresponding to a brightness of a first optical cell and a second signal corresponding to the brightness of a second optical cell; and
the control circuit independently adjusts the brightness of the first optical cell according to the first signal and the brightness of the second optical cell according to the second signal.

54. A display according to claim 31, wherein the display panel comprises a liquid crystal display panel.

55. A display according to claim 54, wherein the sensor comprises a node connected to an electrode of a liquid crystal cell.

56. A display according to claim 31, wherein:
the optical cells are configured in multiple columns and multiple rows; and
the control circuit includes a variable signal source to simultaneously provide a varying signal to the optical cells in multiple columns to adjust the individual brightnesses of the optical cells.

57. A display according to claim 31, wherein:
the optical cells are configured in multiple columns and multiple rows;
the sensor includes a column sensor connected to a column of optical cells, wherein the sensor is configured to sense a sequential signal corresponding to brightnesses of multiple optical cells in the column.

58. A display according to claim 31, wherein:
the optical cells are configured in multiple columns and multiple rows;
the sensor includes a column sensor connected to a column of optical cells, wherein the sensor is configured to sense a brightness sum signal corresponding to the sum of the brightnesses of multiple optical cells in the column.

59. A display according to claim 58, wherein the control circuit is configured to determine the brightness of a single optical cell in the column of optical cells according to a change in the brightness sum signal.

60. A display according to claim 31, wherein:
the optical cells are configured in multiple columns and multiple rows;
the sensor includes a light sensor responsive to multiple optical cells in a column; and
the light sensor provides a brightness sum signal corresponding to the sum of the brightnesses of the multiple optical cells in the column.

61. A display system, comprising:
a display panel comprising multiple optical cells configured in multiple columns and rows, wherein each optical cell comprises:
a storage element for storing a value; and
an optical element configured to provide light according to the value stored in the storage element;
a plurality of sensors, wherein each of the sensors is configured to be responsive to a brightness of at least one of the optical cells in a particular column and provide a brightness signal substantially corresponding to the brightness of the at least one of the optical cells; and
a feedback circuit configured to be selectively connected to each of the optical cells in the particular column and the sensor connected to the particular column, wherein the feedback circuit is configured to adjust the value stored in each storage element in the particular column according to an input signal and the brightness signal from the sensor.

62. A display system according to claim 61, wherein:
the feedback circuit includes a comparison circuit to compare the brightness signal for the at least one of the optical cells to a target value; and
the feedback circuit is configured to adjust the value stored in the storage element of the at least one of the optical cells so that the sensed brightness signal is within a selected range of or identical to the target value.

63. A display system according to claim 62, wherein the feedback circuit further comprises an amplifier connected between the comparison circuit and the sensor and configured to amplify the brightness signal.

64. A display system according to claim 61, wherein the feedback circuit is configured to overdrive the optical cells.

65. A display system according to claim 61, wherein:
the feedback circuit includes a variable signal source to provide a varying signal to the storage elements to adjust the brightnesses of the optical cells; and
the varying signal comprises at least one of an increasing and a decreasing ramp voltage.

66. A display system according to claim 61, wherein:
the feedback circuit includes a variable signal source to provide a varying signal to the storage elements to adjust the brightnesses of the optical cells; and
the varying signal comprises at least one of an increasing and a decreasing step voltage.

67. A display system according to claim 61, wherein:
the feedback circuit comprises a current source to provide a current to the storage elements to adjust the brightnesses of the optical cells; and
the current source provides the current according to a difference between the brightness signal and a target value.

68. A display system according to claim 61, wherein the feedback circuit includes:
a variable signal generator selectively connectable to each storage element to provide a varying signal to each storage element to adjust the value stored in each storage element; and
a current source selectively connectable to each storage element to provide a current to each storage element to adjust the value stored in each storage element.

69. A display system according to claim 68, wherein the variable signal generator and the current source are selectively simultaneously connectable to each storage element.

70. A display system according to claim 61, wherein each sensor includes a resistor connected to a dedicated column to sense the current provided to the column.

71. A display system according to claim 61, wherein each sensor includes a resistor connected to a dedicated column and configured to be selectively connected to each optical cell in the dedicated column to sense the current through the optical cell.

72. A display system according to claim 61, wherein each optical cell further includes a control transistor having a gate connected to the storage element and connected in the current path of the optical element, wherein the control transistor is configured to operate in a subsaturation region.

73. A display system according to claim 61, wherein:
each sensor includes a resistor connected to the optical element in the optical cell; and
the resistor is configured to be selectively connected to the feedback circuit.

74. A display system according to claim 73, wherein:
the optical element includes an OLED; and
the resistor is connected between at least one of (a) a cathode of the OLED and the source of a thin film transistor and (b) an anode of the OLED and ground.

75. A display system according to claim 61, wherein the plurality of sensors includes:
a variable resistor, wherein the resistance of each variable resistor corresponds to the combined brightnesses of multiple optical cells; and
a current source connected to the variable resistor;
wherein the current source supplies only the variable resistor, the brightness signal includes a voltage across the variable resistor, and a sensitivity of the sensor may be increased by increasing the current provided by the current source.

76. A display system according to claim 61, wherein the feedback circuit is configured to store a selected value in the storage element before adjusting the value according to the input signal and the brightness signal.

77. A display system according to claim 61, wherein:
each storage element includes a capacitor for storing a charge; and
the feedback circuit is configured to discharge the capacitor to a substantially known charge before adjusting the value according to the input signal and the brightness signal.

78. A display system according to claim 61, wherein the feedback circuit is further configured to substantially maintain the adjusted value stored on the storage element according to the brightness signal for a remaining duration of a row address cycle.

79. A display system according to claim 61, wherein the feedback circuit:
includes a comparison circuit to compare the brightness signal to a target value; and
is configured to maintain the brightness of the at least one of the optical cells within a selected range of or identical to the target value.

80. A display system according to claim 61, wherein the feedback circuit:
includes a power source and a power sink; and
is configured to adjust the value according to the brightness signal by selectively connecting each storage element to the power source and the power sink.

81. A display system according to claim 61, wherein:
each sensor senses a first signal corresponding to a brightness of a first optical cell and a second signal corresponding to the brightness of a second optical cell in the particular column; and
the feedback circuit independently adjusts the value of the first optical cell's storage element according to the first signal and the value of the second optical cell's storage element according to the second signal.

82. A display system according to claim 61, wherein the display panel comprises a liquid crystal display panel.

83. A display system according to claim 82, wherein the sensor comprises a node connected to an electrode of a liquid crystal cell.

84. A display system according to claim 61, wherein the feedback circuit includes a variable signal source to simultaneously provide a varying signal to the storage elements in multiple columns to adjust the individual values stored on the storage elements.

85. A display system according to claim 61, wherein each sensor is configured to sense a sequential signal corresponding to brightnesses of multiple optical cells in the particular column.

86. A display system according to claim 61, wherein each sensor is configured to sense a brightness sum signal corresponding to the sum of the brightnesses of multiple optical cells in the column.

87. A display system according to claim 86, wherein the feedback circuit is configured to determine the brightness of a single optical cell in the particular column according to a change in the brightness sum signal.

88. A display system according to claim 61, wherein:
each sensor includes a light sensor responsive to multiple optical cells in the particular column; and
the light sensor provides a brightness sum signal corresponding to the sum of the brightnesses of the multiple optical cells in the column.
